(19) United States
(12) Patent Application Publication
(10) Pub. No.: US 2012/0195509 A1
(43) Pub. Date: Aug. 2, 2012

(54) IMAGE SIGNAL PROCESSING APPARATUS AND IMAGE SIGNAL PROCESSING METHOD

(75) Inventor: Shugo KONISHI, Tokyo (JP)

(73) Assignee: Kabushiki Kaisha Toshiba, Tokyo (JP)

(21) Appl. No.: 13/243,760

(22) Filed: Sep. 23, 2011

(30) Foreign Application Priority Data
Jan. 31, 2011 (JP) P2011-019242

(51) Int. Cl. G06K 9/62

(52) U.S. Cl. 382/224

(57) ABSTRACT

According to one exemplary embodiment, an image signal processing apparatus is provided with: a classification module which classifies texture information representing texture of an object; an analyzer which analyzes, based on the classified texture information, material information that represents a material of the object and is included in an input image signal; and a generator which generates a parallax image signal from the input image signal based on the material information.

### CROSS REFERENCE TO RELATED APPLICATION(S)

The application is based upon and claims the benefit of priority from Japanese Patent Application No. 2011-019242 filed on Jan. 31, 2011; the entire content of which are incorporated herein by reference.

### FIELD

Exemplary embodiments described herein relate generally to an image signal processing apparatus and an image signal processing method for generating parallax images.

### BACKGROUND

Apparatuses for converting two-dimensional (2D) images into three-dimensional (3D) images are used. For example, a technique for generating parallax images for converting two-dimensional images into three-dimensional images is known.

However, there are demands for capabilities of generating more accurate images, e.g., capabilities of representing more realistic texture.

### BRIEF DESCRIPTION OF THE DRAWINGS

Exemplary embodiments of the present invention will be described in detail based on the following figures, wherein:

FIG. 1 is a block diagram showing a configuration of an embodiment according to the present invention;

FIG. 2 is a functional block diagram showing an example of a configuration of a television set having an image signal processing apparatus according to the embodiment;

FIGS. 3A to 3D are schematic diagrams showing advantages of the embodiment;

FIG. 4 is a block diagram showing a configuration of an example of the image signal processing apparatus according to the embodiment;

FIGS. 5A to 5E are diagrams showing an example of a configuration of a database of the distribution of reflectivity used in the embodiment;

FIG. 6 is a diagram showing a method for generating an image in an image generation portion according to the embodiment;

FIG. 7 is a diagram showing reflection caused when light is irradiated onto a glossy sphere from front by a penlight; and

FIG. 8 is a diagram showing reflection caused when light is irradiated onto the glossy sphere from an angle of 55 degrees shifted leftward with respect to the front by the penlight.

### DETAILED DESCRIPTION OF THE EXEMPLARY EMBODIMENTS

In general, according to one exemplary embodiment, an image signal processing apparatus is provided with: a classification module which classifies texture information representing texture of an object; an analyzer which analyzes, based on the classified texture information, material information that represents a material of the object and is included in an input image signal; and a generator which generates a parallax image signal from the input image signal based on the material information.

Hereinafter, an embodiment of the invention is described.

### First Embodiment

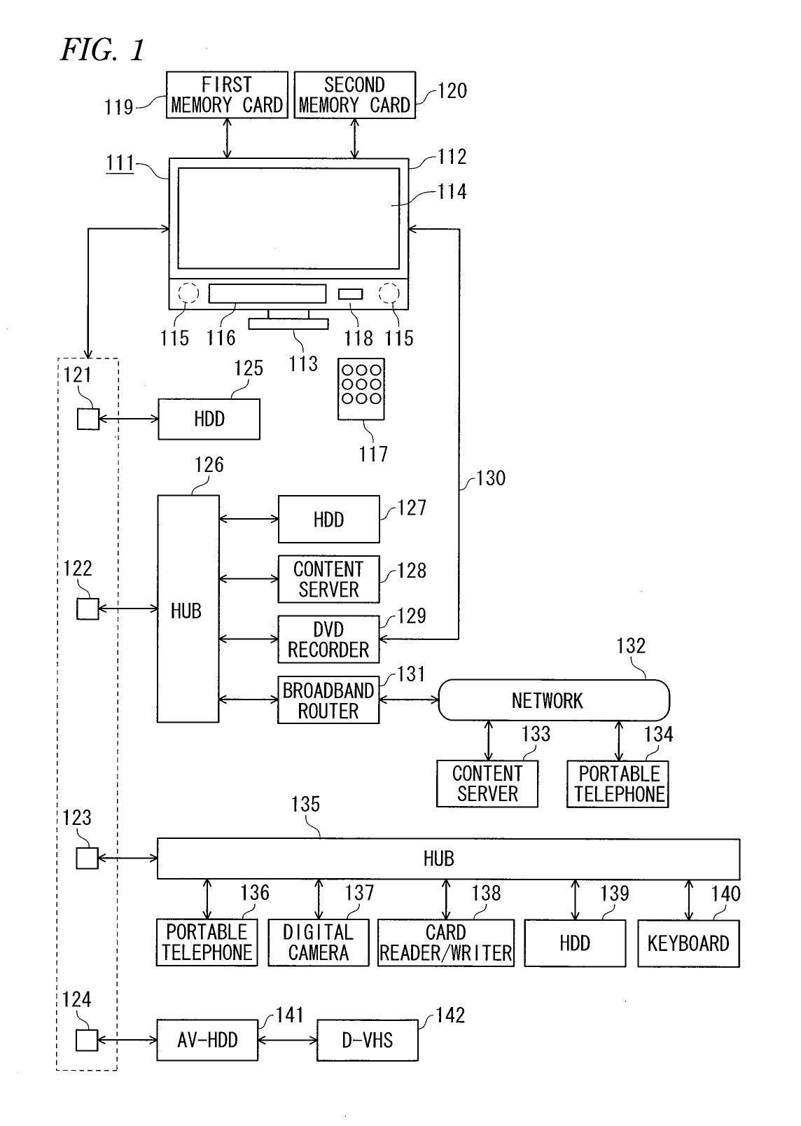

A first embodiment according to the invention is described with reference to FIGS. 1 to 6.

FIG. 1 schematically shows the appearance of a digital television broadcast receiving apparatus 111 (hereinafter, called “digital TV 111”) and an example of a network system configured by being centered on the digital TV 111.

That is, the digital TV 111 is configured mainly by a thin cabinet 112 and a support stand 113 on which the cabinet 112 is supported by being erected. Then, the cabinet 112 is provided with a flat panel type image display device 114 configured by, e.g., a surface-conduction electron-emitter display (SED) panel, a liquid crystal display panel, or the like, and with a speaker 115, an operation module 116, a light receiver 118 for receiving operation information transmitted from a remote controller 117, and the like.

For example, a first memory card 119 such as a secure digital (SD) memory card, a multimedia card (MMC), a memory stick, or the like can be attached to and detached from the digital TV 111. Information representing a program, a photograph, and the like is recorded in and reproduced from the first memory card 119.

In addition, a second memory card (i.e., an integrated circuit (IC) card) 120 in which, e.g., contract information is recorded can be attached to and detached from the digital TV 111. Such information can be recorded in and reproduced form the second memory card 120.

The digital TV 111 has a first local area network (LAN) terminal 121, a second LAN terminal 122, a universal serial bus (USB) terminal 123, and what is called an i.LINK (registered trademark) terminal 124.

Among the terminals, the first LAN terminal 121 is used as a LAN-compatible hard disk drive (HDD) dedicated port. More specifically, the first LAN terminal 121 is used to record and reproduce, via an Ethernet (registered trademark), information in and from a LAN-compatible HDD 125 serving as a network-attached-storage (NAS) connected thereto.

Thus, the provision of the first LAN terminal 121 serving as the LAN-compatible HDD dedicated port enables the digital TV 111 to stably record information representing a program with high-vision image quality in the LAN-compatible HDD 125 without being affected by another network environment and the status of use of another network.

The second LAN terminal 122 is used as a general LAN-compatible port using Ethernet. The second LAN terminal 122 is connected to a LAN-compatible HDD 127, a content server 128, a digital versatile disk (DVD) recorder 129 incorporating an HDD, and the like via, e.g., a hub 126. The second LAN terminal 122 is used for transmission of information to and from the above devices connected thereto.

The content server 128 has a function for operating as a content server device in a home network. In addition, the content server 128 is configured as a universal-plug-and-play (UPnP)-compatible apparatus having a service of providing uniform resource identifier (URI) information needed to access contents.

Since digital information communicated via the second LAN terminal 122 is only control system information, it is necessary for transmitting analog image/audio information between the DVD recorder 129 and the digital TV 111 to provide a dedicated analogue transmission path 130 therebetween.

The second LAN terminal 122 is also connected to a network 132 such as the Internet via a broadband router 131 connected to the hub 126. The second LAN terminal 122 is used for transmission of information between the digital TV 111 and each of a content server 133, a portable telephone 134, and the like via the network 132.

The content server 133 has a function for operating as a content server in a home network. In addition, the content server 133 is configured as a UPnP-compatible apparatus having a service of providing URI information necessary for accessing contents.

The above USB terminal 123 is used as a general USB-compatible port. For example, the USB terminal 123 is connected via a hub 135 to USB devices such as a portable telephone 136, a digital camera 137, a card reader/writer 138 corresponding to the memory card, an HDD 139, and a keyboard 140. The USB terminal 123 is used for transmission of information between the digital TV 111 and each of the above USB devices.

In addition, the above i.LINK terminal 124 is used to establish serial connection to, e.g., an audio-visual hard disk drive (AV-HDD) 141 and a digital-video home system (D-VHS) 142 to perform transmission of information to these devices.

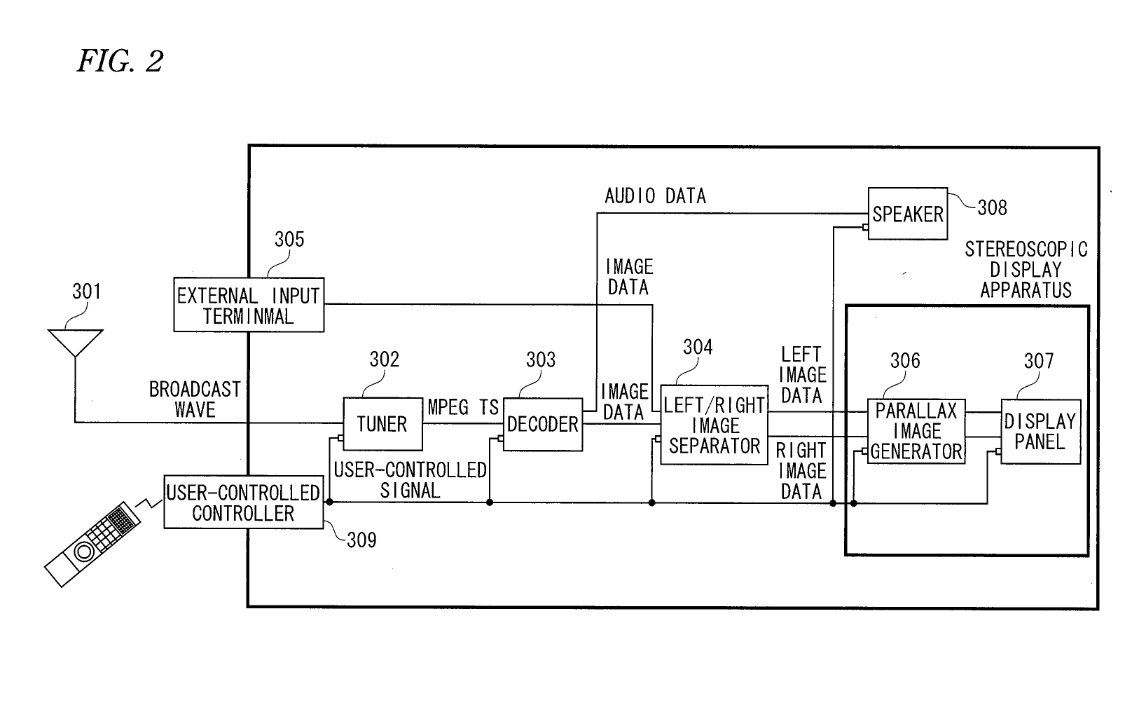

FIG. 2 is a functional block diagram showing a configuration of a principal signal processing system of the above digital TV 111. As shown in FIG. 2, the digital TV 111 is configured to include an antenna 301, a tuner 302, a decoder 303, a left-right image separator 304, an external input terminal 305 (corresponding to each of the terminals 121 to 124 and 130), a parallax image generator 306, and a display panel 307.

First, a broadcast wave input from the antenna 301 pass through the tuner 302 and the decoder 303, so that image data is obtained. Then, the image data is input to the left-right image separator 304 (image data to be input to the left-right image separator 304 can be input from the external input terminal 305). After that, the input image data is separated by the left-right image separator 304 into left-eye image data representing an image to be viewed by the left eye of a user, and right-eye image data representing an image to be viewed by the right eye thereof. Then, the parallax image generator 306 (corresponding to an image signal processing apparatus 200 to be described below) analyzes each image and generates an image based on an analysis result. Then, the generated image is displayed by the display panel 307.

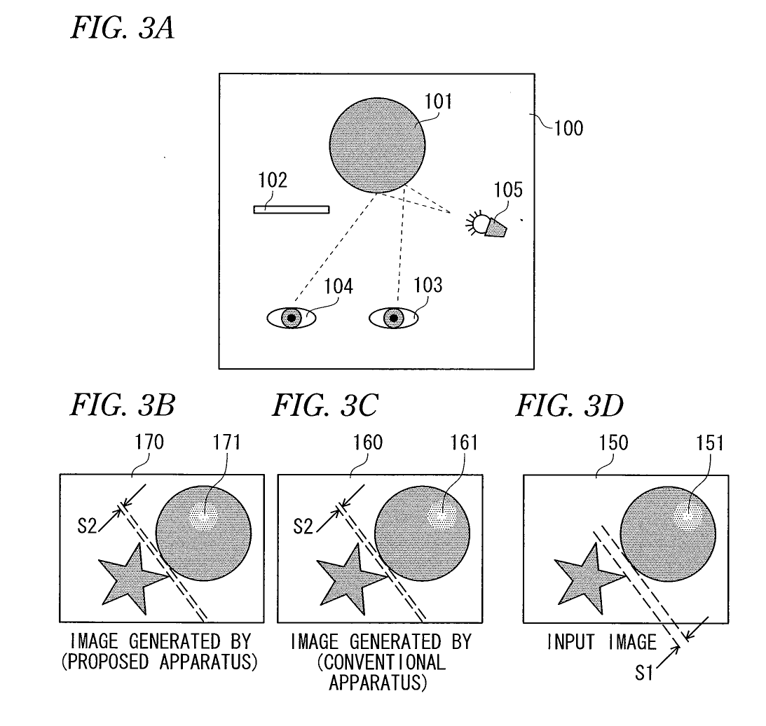

FIGS. 3A to 3D are schematic diagrams showing advantages of the embodiment. Reference numeral 100 designates a view, taken, from directly above, showing a space in which certain objects are provided. In this space, a spherical object 101, a star-shaped object 102, and a light source 105 are provided. When an image 150 containing the objects, which is taken from a viewing point 103, exists, an image taken from another viewing point 104 is generated, as will be described below. At that time, an image generated based on a conventional method of laterally shifting objects according to depth information is obtained as indicated by reference numeral 160. In the image 160, the distance between the spherical object 101 and the star-shaped object 102 is reduced from S1 to S2.

However, according to the method described hereto, the position of a highlighted part 151 in the image 150 is that of a highlighted part 161 in the image 160. Therefore, the position of the highlighted part doesn't change. Hereinafter, an apparatus is described, which generates a more accurate parallax image 170 by taking the reflection characteristic of an object into consideration. Although the light source 105 is illustrated as close to the object 101 and the like for convenience of description, an external light, a ceiling lamp, or the like providing parallel light rays can be assumed as the light source.

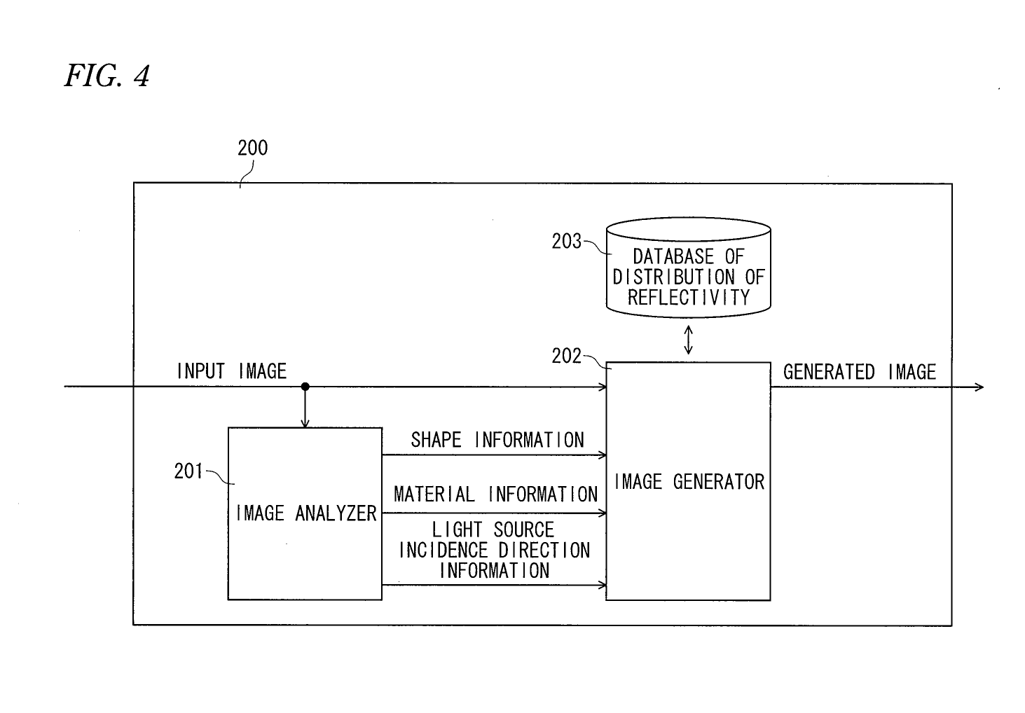

FIG. 4 shows an example of a configuration of the image signal processing apparatus corresponding to the parallax image generator 306. In this example, the image signal processing apparatus generates, from a single parallax image, another parallax image. However, two or more parallax images can be input to the image signal processing apparatus. In addition, the image signal processing apparatus can generate two or more parallax images.

The image signal processing apparatus 200 is configured to include an image analyzer 201, an image generator 202 and a database 203 of the distribution of reflectivity.

First, the image analyzer 201 analyzes an input image concerning the shape, the material and the direction of incidence of light from the light source. This analysis can be performed by a known method. For example, the direction of incidence of light from the light source can be obtained by inputting the image 150 thereto. The shape and the material of each object can be estimated by the expanse and the contrast of the part 151. Next, it is sufficient to consider, when the image 160 is input thereto, the difference between the positions of the viewing points in addition to information representing the direction of incidence of light from the light source.

The depth of an object can be known by, e.g., a known technique for conversion between a 2D-image and a 3D-image. Then, the shape of the object can be identified according to change of the depth.

The material of an object can be identified by performing a general pattern recognition technique (e.g., a face recognition technique, or a person search technique) on materials such as metals and fibers.

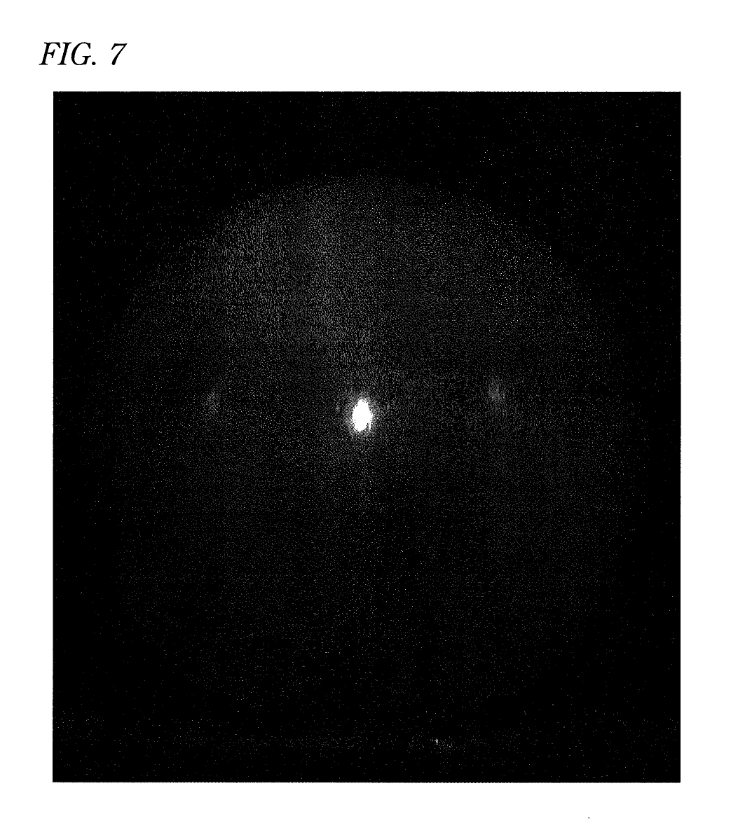

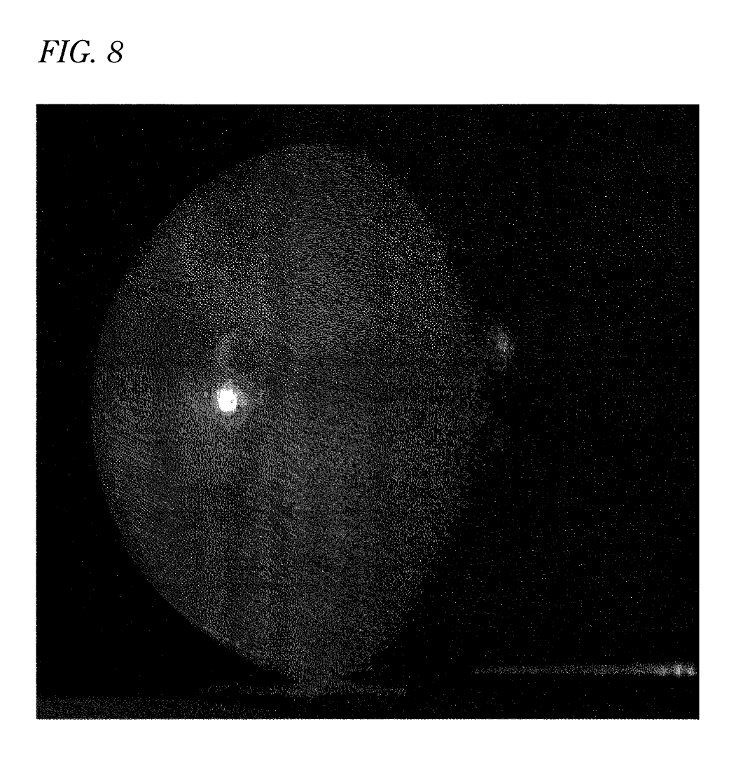

When the shape (or the direction of a surface) of an object is known by the above technique, the direction of incidence of light from the light source can be found by calculation according to the position of the highlighted part. More specifically, the direction of incidence of light from the light source is a direction in which light passing along a straight line-segment connecting the viewing point and the position of the highlighted part is reflected by a surface at a highlighted position. For example, FIG. 7 shows a glossy sphere's part that shines most brightly due to reflection of light irradiated thereonto from the front thereof by a penlight. FIG. 8 shows a glossy sphere's part that shines most brightly due to reflection caused when light is irradiated onto the glossy sphere from an angle of 55 degrees shifted leftward with respect to the front by the penlight.

Next, the image generator 202 generates a parallax image corresponding to an optional viewing point, based on the input image and information analyzed by the image analyzer 201. When performing processing, the image generator 202 utilizes the database 203 (corresponding to a classification means for classifying texture information representing the texture of each object) of the distribution of reflectivity.

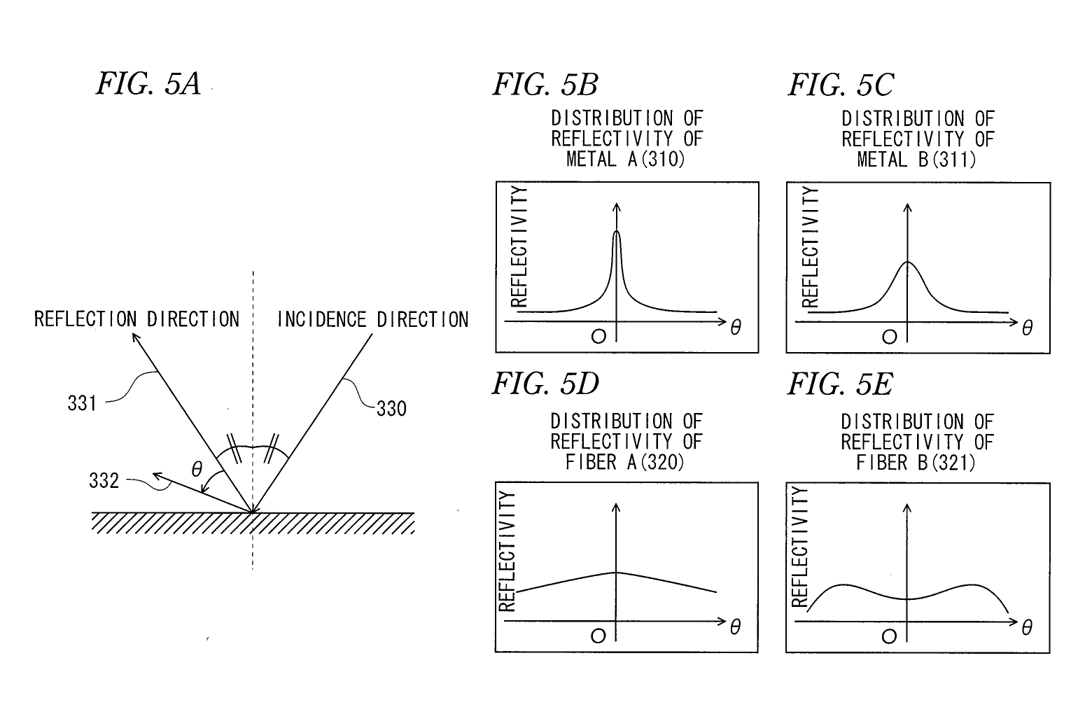

FIGS. 5A to 5E show an example of a configuration of the database 203 of the distribution of reflectivity. Generally, when light is incident upon an object in an incidence direction 330, light is reflected in a reflection direction 331 symmetric with respect to a normal-line of a surface of the object. At the reflection, light is scattered due to the property (texture) of the surface of the object. In this example, it is assumed that the reflectivity of the scattered light can be expressed as a function of an angle θ formed between each light ray and the reflection direction of the light. Data representing the distribution of reflectivity corresponding to each of types of materials (metal A, metal B, fibers A and fibers B respectively corresponding to graphs 310, 311, 320 to 321) are stored. The graph 321 corresponding to the fibers B shows data representing a unique distribution in which the reflectivity is not maximized at θ=0.

Actually, information representing a distribution in the form more complex or simpler than the form, in which distributions are represented by such distribution data, can be used. The distribution data can be saved in the form of, e.g., a simple table describing sets of the values of the angle θ and those of the reflectivity corresponding to the angle θ. An example of the complex information representing the distribution can be set, instead of a smooth function, by additionally taking into consideration a minute variation with periodicity due to the roughness of the material.

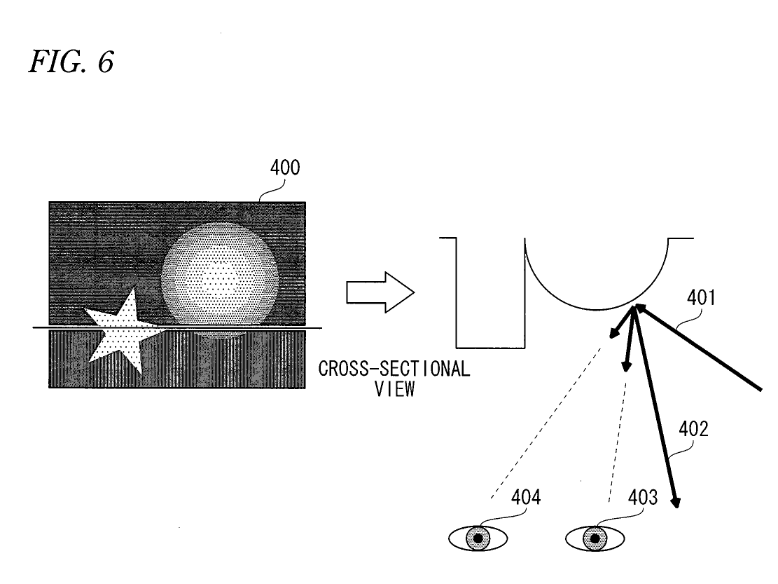

FIG. 6 shows an example of a method of generating an image in the image generator 202. Hereinafter, a parallax image is generated from an input image representing shapes designated with reference numeral 400 (in the input image, the higher the luminance of a part having each shape, the closer to an observer of the input image the part is located). First, when a certain pixel is generated, the image generator 202 searches the input image for a part of an object, which corresponds to the certain pixel. Then, a reflection direction 402 is calculated according to an incidence direction 401 of incidence of light from the light source and to the inclination of a surface of the part of the object. Next, based on material information representing the material of each object, the distribution of reflectivity of the material is referred to in the database 203 of the distribution of reflectivity. Then, the pixel values of an image to be generated from the input image are calculated according to the incidence direction 402 and the distribution of the reflectivity of the material. Similarly, the pixel values of all pixels of a surface supposed to be a curved surface are calculated. Thus, a parallax image is generated.

The image generator 202 for generating a parallax image is used when a binocular 3D image is generated from a 2D image in a pseudo manner, and when a multi-view 3D image is generated from a binocular 3D image. The use of the image generator 202 enables the generation of a more accurate parallax image. In addition, the use of the image generator 202 enables the representation of realistic texture, as shown in FIGS. 5A to 5E.

For example, an image of a light source is often reflected from a metallic portion as that of a highlighted part. At that time, in the case of some shape of an object and a position of the light source, the value of the luminance of light incident on the right eye of an observer differs from that of the luminance of light incident on the left eye thereof. However, according to a conventional parallax image generation method, the luminance of one of the left eye's image and the right eye's image is determined, based on that of the other eye's image. Thus, even in this case, the luminance of light incident on the left eye is equalized to that of light incident on the right eye. Then, the observer recognizes this part as a part to which a high lightness color is given, instead of the highlighted part appearing on the metallic portion. Occurrence of this problem can be prevented by generating a parallax image using the above-described image generator 202.

While certain exemplary embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image signal processing apparatus comprising:
a classification module configured to classify texture information representing texture of an object;
an analyzer configured to analyze, based on the classified texture information, material information which represents a material of the object and is included in an input image signal; and
a generator configured to generate a parallax image signal from the input image signal based on the material information.

2. The apparatus of claim 1, wherein the generator is configured to generate the parallax image signal based on a shape or a depth of the object, in addition to the material information.

3. The apparatus of claim 1, wherein the generator is configured to generate the parallax image signal based on a direction in which light is incident on the object, in addition to the material information.

4. The apparatus of claim 1 further comprising:
a display panel configured to display the parallax image signal.

5. An image signal processing method comprising:
classifying texture information representing texture of an object;
analyzing, based on the classified texture information, material information which represents a material of the object and is included in an input image signal; and
generating a parallax image signal from the input image signal based on the material information.
